(19) United States
(12) Patent Application Publication
(10) Pub. No.: US 2019/0372409 A1
(43) Pub. Date: Dec. 5, 2019

(54) STATOR CLAMP

(71) Applicant: GALATECH, INC., MILPITAS, CA (US)

(72) Inventors: Wenjun Liu, Santa Clara, CA (US); Robert James Ramm, Mountain View, CA (US)

(21) Appl. No.: 15/993,490

(22) Filed: May 30, 2018

(51) Int. Cl. H02K 1/18; H02K 5/24; H02K 7/116; H02K 11/33

(52) U.S. Cl. CPC H02K 1/185; H02K 5/24; B60L 11/1803; H02K 11/33; H02K 7/116

(57) ABSTRACT

A drive unit for an electric vehicle includes a stator having an axis extending through an opening in the middle of the stator, a case, a clamp to fasten the stator within the case and a fastener. The case includes a boss with an opening having an axis and a ramp adjacent to the boss and slanting toward the axis of the stator as it extends away from the opening of the boss. The clamp includes a first portion to contact a side of the stator to provide a radial force to the stator and a second portion to contact an end of the stator to provide an axial force to the stator. The fastener is inserted through the clamp into the boss. The slanted edge is configured to slide against the ramp when the fastener is inserted into the boss, to generate the radial force.

### TECHNICAL FIELD

This relates generally to powertrains for electric vehicles, including but not limited to powertrains having an inverter, a motor including a stator and a rotor, and a gearbox.

### BACKGROUND

The powertrain of an electric vehicle includes a battery, an inverter, a motor, and a gearbox. The motor is part of a drive unit of the electric vehicle. Misalignment, especially between bearings, is problematic with regard to noise, vibration, and harshness (NVH).

### SUMMARY

In some implementations, a drive unit for an electric vehicle includes a stator having an axis extending through an opening in the middle of the stator, a case, a clamp to fasten the stator within the case and a fastener. The case includes a boss with an opening having an axis and a ramp adjacent to the boss and slanting toward the axis of the stator as it extends away from the opening of the boss. The clamp includes a first portion to contact a side of the stator to provide a radial force to the stator and a second portion to contact an end of the stator to provide an axial force to the stator. The fastener is inserted through the clamp into the boss. The slanted edge is configured to slide against the ramp when the fastener is inserted into the boss, to generate the radial force.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIGS. 1A-1C are respective side views of a casting in accordance with some implementations.

FIG. 2 is a cross-sectional view showing components within the casting of FIGS. 1A-1C in accordance with some implementations.

FIG. 3 is a cross-sectional view showing components within the casting of FIGS. 1A-1C in accordance with some implementations.

FIG. 4 is a view showing a clamp disposed within the casting in accordance with some implementations.

FIG. 5 is a cross-sectional view of the clamp in accordance with some implementations.

FIG. 6 illustrates a plurality of clamps in accordance with some implementations.

FIG. 7 is a view illustrating the casting of the motor in accordance with some implementations.

FIG. 8 is a diagram illustrating a top view of the casting of the motor in accordance with some implementations.

FIG. 9 illustrates components within the casting in accordance with some implementations.

Like reference numerals refer to corresponding parts throughout the drawings and specification. Like fill patterns indicate corresponding parts throughout the drawings.

### DETAILED DESCRIPTION

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Many modifications and variations of this disclosure can be made without departing from its spirit and scope, as will be apparent to those skilled in the art. The specific implementations described herein are offered by way of example only, and the disclosure is to be limited only by the terms of the appended claims, along with the full scope of equivalents to which such claims are entitled.

In a conventional electric motor, the stator is press-fitted into its casing, fixing the position of the stator with respect to the casing. The casing is also fixed with respect to a bearing that holds in place the axle of the rotor and allows the axle to rotate with respect to the stator. On the opposite end, the axle is held in place by a bearing that is fixed with respect to a gear box. Thus, in a conventional motor, the stator is fixed with respect to the bearings, and therefore contributes to the tolerance stack-up between the two bearings. As noted above, the tolerance stack-up between the two bearings causes NVH problems.

In some implementations, a stator in an electric motor is clamped rather than press-fitted into its casing. By doing so, the position of the stator is not absolutely fixed with respect to its casing and, therefore, does not contribute to the tolerance stack-up between the two bearings holding the rotor axle in place. There are thus fewer components whose tolerance contributes to the tolerance stack-up between the two bearings, which improves the NVH performance of the motor.

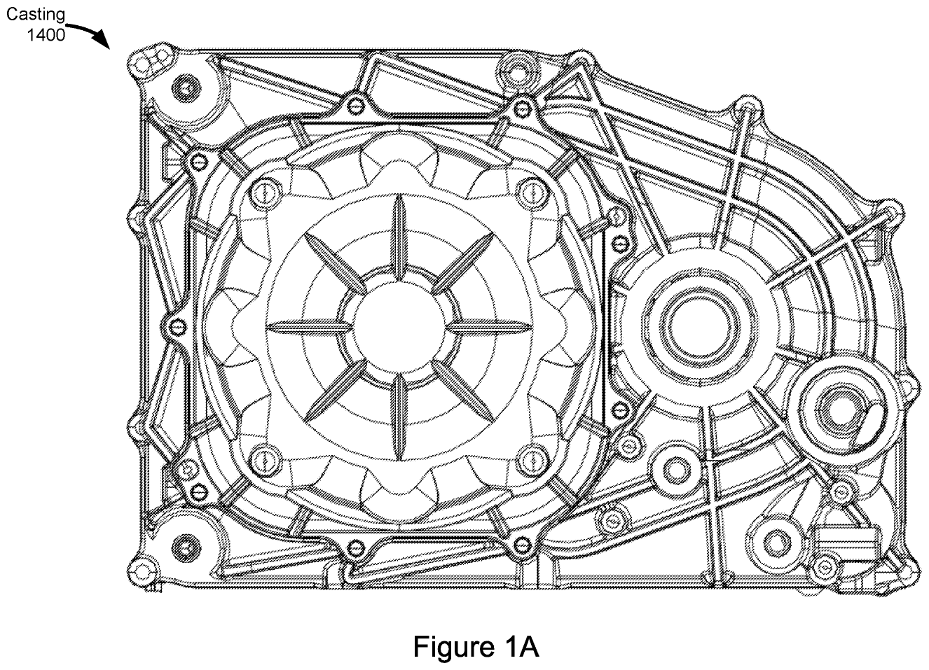

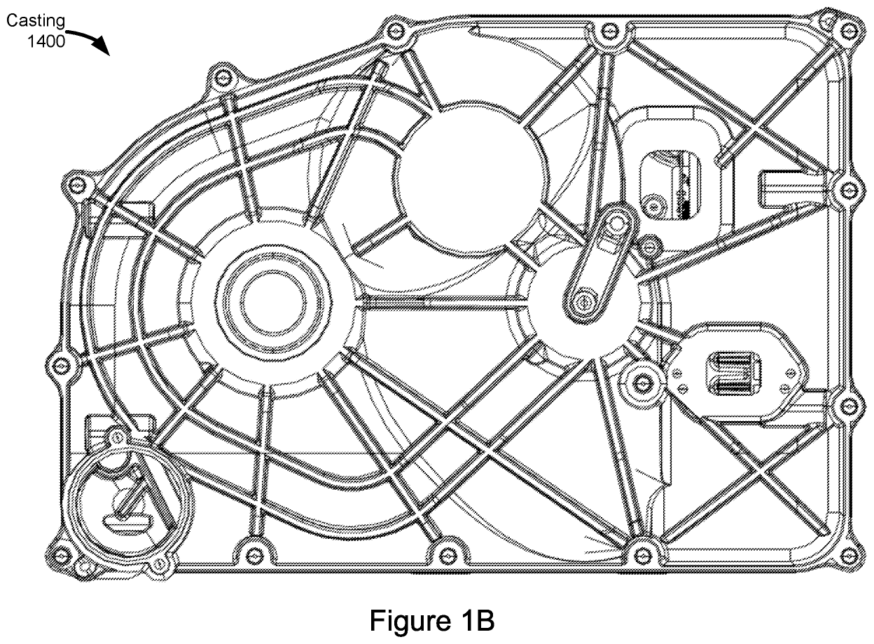

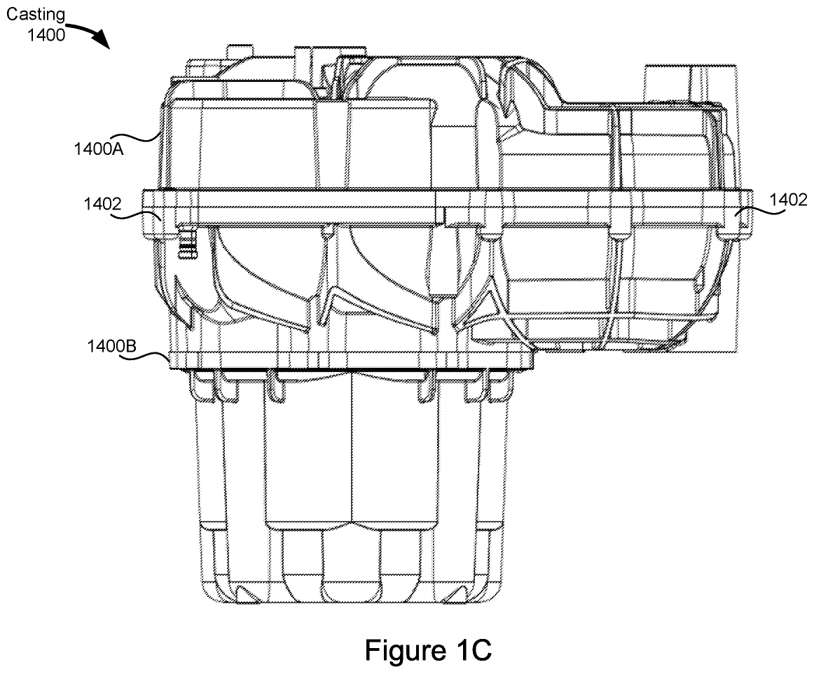

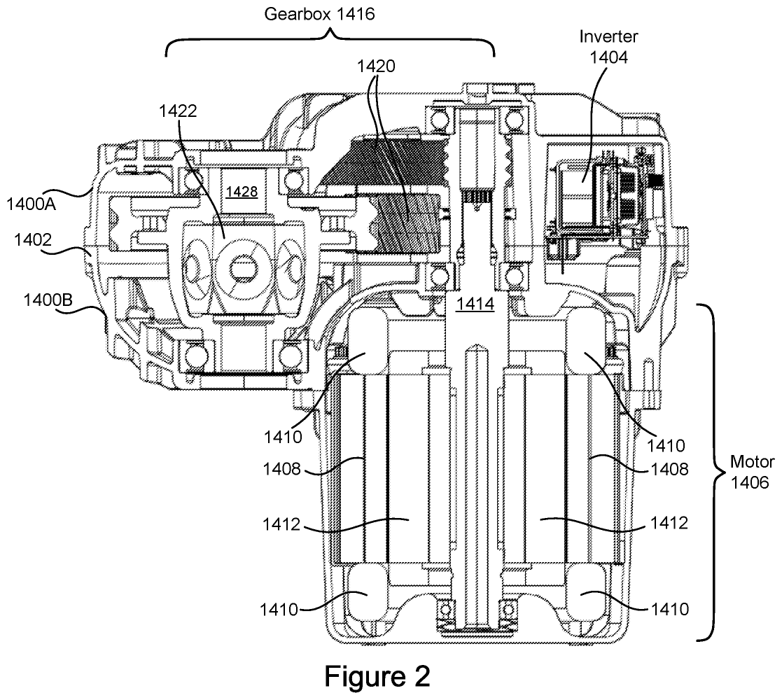

FIGS. 1A-1B are respective side views of a casting 1400. In some implementations, an inverter (e.g., the inverter 1404, FIG. 2) is housed in the same casting that houses the electric motor and gearbox. The side view of FIG. 1B is opposite to the side view of FIG. 1A. The side view of FIG. 1C results from rotating the casting 1400 90 degrees in appropriate directions with respect to the side views of FIGS. 1A and B5. As shown in FIG. 1C, the casting 1400 may include a first portion 1400A and a second portion 1400B that are joined (e.g., bolted together) using bosses 1402 during assembly, to encase components within the casting 1400. The casting 1400 may be manufactured by die casting and may be aluminum.

FIG. 2 is a cross-sectional view showing components within the casting 1400 in accordance with some implementations. These components include an inverter 1404, electric motor 1406, and gearbox 1416. The inverter 1404 receives DC power from a battery external to the casting 1400 and converts the DC power to AC power, which is provided to the motor 1406. The motor 1406 includes a rotor 1412 inside a stator 1408. The stator 1408 has associated stator windings 1410, to which the AC power from the inverter 1404 is coupled at both ends (e.g., the stator windings 1410 are electrically coupled to the output (e.g., phase-out bus bars) of the inverter 1404). In this manner, the inverter 1404 is coupled to the motor 1406 to provide the AC power to the motor 1406. The rotor 1412 includes a rotor shaft 1414 that extends beyond one end of the stator 1408. The gearbox 1416 includes a gear on the rotor shaft 1414, intermediate gearing 1420, and a final gear 1422 (e.g., a differential gear). The intermediate gearing 1420 couples the rotor shaft 1414 with the final gear 1422. The rotor shaft 1414 is situated between the inverter 1404 and components of the gearbox 1416, including the intermediate gearing 1420 and final gear 1422 but excluding the gear 1418, as shown. A portion of the intermediate gearing 1420, however, may overlap the rotor shaft 1414, as shown.

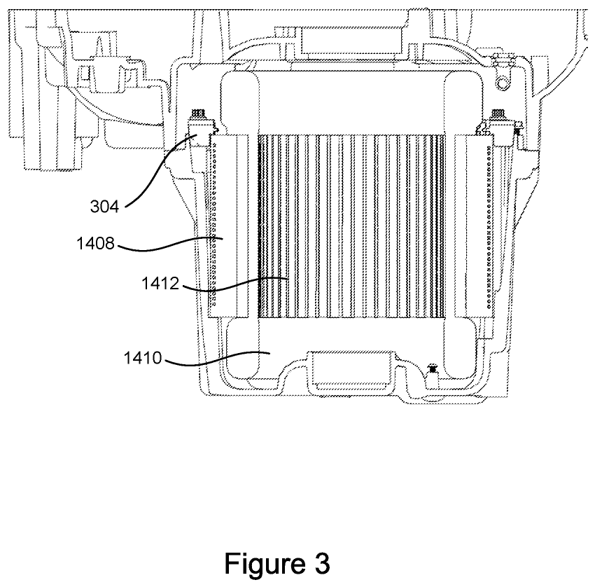

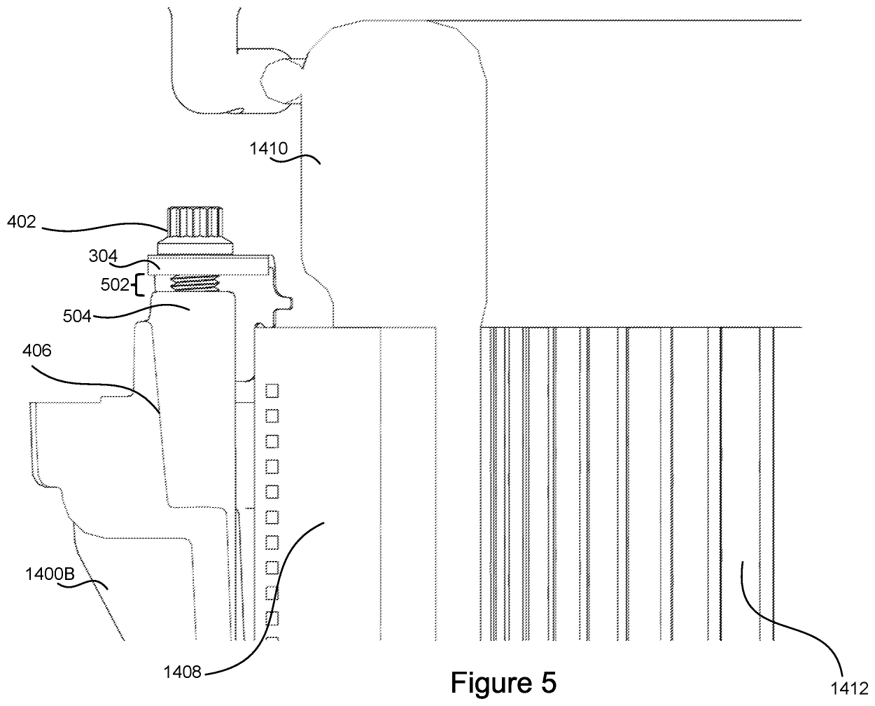

FIG. 3 is a cross-sectional view of a drive unit for an electric vehicle. The drive unit includes the motor 1406 within the casting 1400, including the stator windings 1410, the rotor 1412 and the stator 1408. In some embodiments, the rotor 1412 has an axle aligned with the axis of the stator extending through an opening in the middle of the stator. The drive unit comprises stator 1408 having an axis extending through an opening in the middle of the stator. The drive unit further includes a case (e.g., a stator case). As shown in FIG. 5, the case comprises (e.g., has formed therein) a boss 504 with an opening having an axis and a ramp 406 adjacent to the boss and slanting toward the axis of the stator as it extends away from the opening of the boss. In some embodiments, the stator case houses the stator (and rotor). In some embodiments, the stator case travels the length of the stator. In some embodiments, the stator case is part of the casting 1400B (e.g., the casting 1400B includes the case). The drive unit further comprises a clamp 304 to fasten (e.g., hold) the stator within the case (e.g., clamps the stator to the casting). In some embodiments, the case includes a bottom surface against which the bottom of the stator sits.

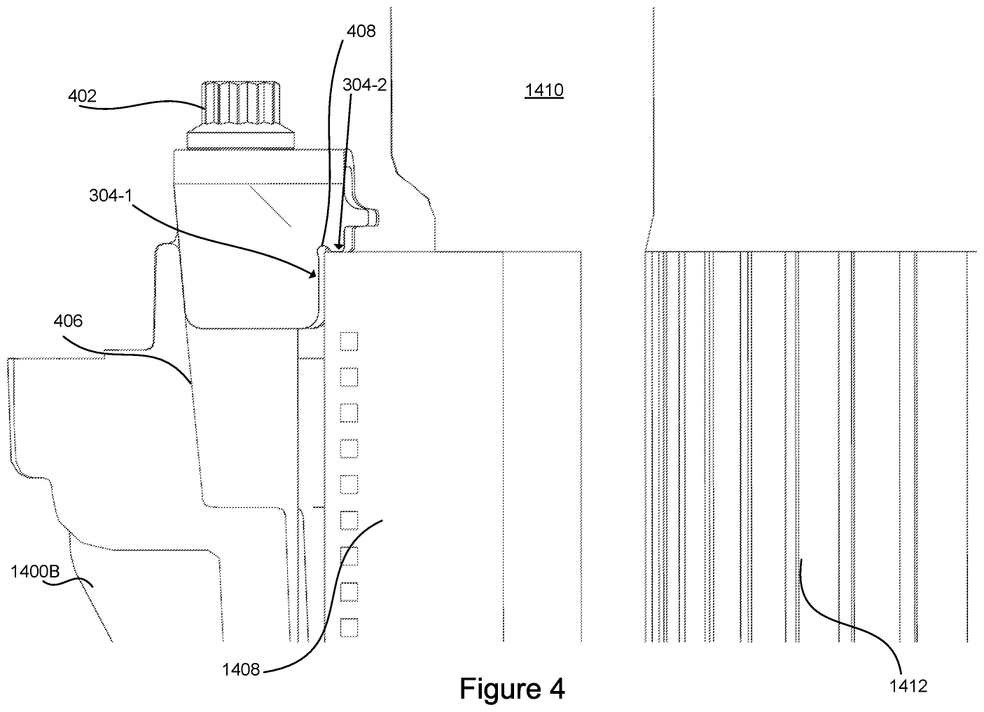

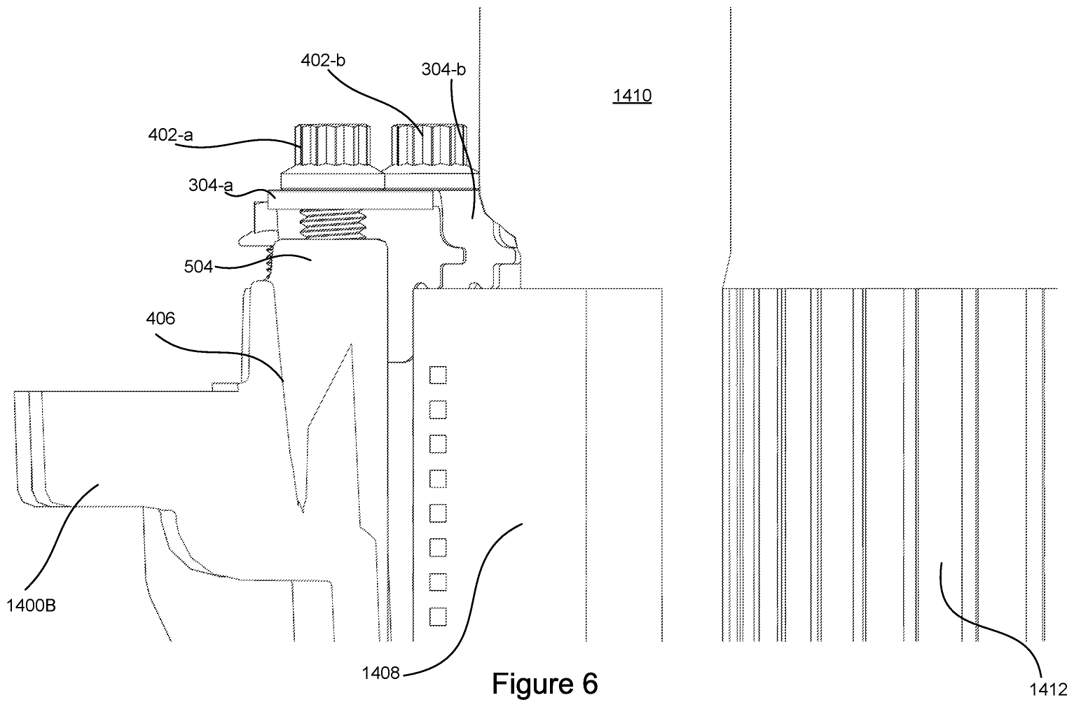

FIG. 4 illustrates a zoomed-in view of the clamp 304 holding the stator 1408 and rotor 1412 in place within the casting 1400B. The clamp 304 is mounted along a slanted edge 406 (e.g., a ramp), which may be formed as part of the casting 1400B (e.g., the slanted edge is formed by including it in the molding when making the casting). The stator clamp further comprises a boss (e.g., a boss for receiving a fastener 402). The clamp 304 comprises a first portion (e.g., protrusion 304-1) to contact a side of the stator to provide a radial force to the stator and a second portion (e.g., protrusion 304-2) to contact an end of the stator to provide an axial force to the stator. In some embodiments, the axial force provided to the stator clamps the stator axially against the bottom surface of the case. As described below with reference to FIG. 6, in some embodiments, a plurality of analogous clamps is used. In some embodiments, the radial force from the plurality of clamps holds the stator radially in place.

In some embodiments, the end of the stator comprises the top of the stator (e.g., the top lamination of the stator). In some embodiments, the side of the stator comprises a portion of the cylindrical length of the stator (e.g., the side of the stator is defined with respect to the circumference of the stator). The clamp 304 further comprises a slanted edge contacting the ramp 406.

In some embodiments, the clamp comprises sheet metal (e.g., is manufactured by stamping sheet metal). In some embodiments, the metal sheet is bent to form a top surface, a first surface, and a second surface, as described below with respect to FIG. 5. In some embodiments, the first portion of the clamp comprises a first protrusion 304-1 and the second portion of the clamp comprises a second protrusion 304-2. In some embodiments, the first protrusion is substantially perpendicular to the second protrusion. In some embodiments, the clamp further comprises a notch 408 between the first and second protrusions. As shown in FIG. 4, the shape of protrusion(s) and notch(es) (e.g., cutouts) are rounded. For example, creating ninety-degree edges may not be practical given the stamping manufacturing process, thus the shape of the edges, protrusions, cutouts, and/or notches may vary (e.g., may be rounded at different angles) in accordance with manufacturing techniques of the clamp. For example, notch 408 is substantially round. In some embodiments, notch 408 is circular. Thus, a notch can be easily formed by drilling a hole in the stamped sheet metal, simplifying manufacturing, or by using a pattern for stamping the sheet metal that includes a rounded portion corresponding to the notch. In some embodiments, the notch is configured (e.g., is large enough given its location) to accommodate downward (e.g., axial) movement of the clamp as the fastener is tightened against the clamp and to accommodate radial movement of the clamp as the fastener is tightened against the clamp.

In some embodiments, using the clamp to hold the stator within the stator case allows for the stator to be held in place separately from (e.g., not included in) the tolerance stackup of the drive unit (e.g., the accumulated variation of the assembly of the components of the drive unit). Traditionally, the tolerance stackup of the drive unit includes (accounts for) the stator, for example, when the stator is press-fitted into the stator case. By instead using the clamp 304 to clamp the stator to the casting, the stator may be removed from the tolerance stackup which allows for tighter assembly tolerances on the drive unit, while maintaining reliable support of the stator (e.g., by clamping the stator to the casting 1400). The assembly tolerance of the drive unit is important because a tighter the assembly tolerance decreases the noise, vibration, and harshness (NVH) that can wear on the gears (e.g., in gearbox 1416).

FIG. 5 illustrates a cross-sectional and zoomed-in view of the clamp 304 shown in FIG. 4. The case comprises a boss 504 with an opening having an axis and a ramp 406 adjacent to the boss and slanting toward the axis of the stator (e.g., the axis is defined vertically through the stator 1408) as it extends away from the opening of the boss. The drive unit further includes a fastener 402 that is inserted through the clamp 304 into the boss 504. A first surface (e.g., the front-most surface) of the clamp has been removed in FIG. 5 to illustrate fastener 402 inserted through the opening of the boss. In some embodiments, the fastener is a threaded fastener. In some embodiments, the threaded fastener has external male threads. In some embodiments, the boss includes or has formed therein a female threaded hole. In some embodiments, the fastener 402 comprises a screw. For example, when the fastener is a screw, the insertion of the fastener into the boss comprises screwing the screw into the boss.

In some embodiments, the clamp 304 further comprises a top surface through which the fastener 402 is inserted (e.g., the fastener is inserted through the clamp and into the opening of the boss). In some embodiments, the fastener is inserted through a non-threaded hold in the top surface of the clamp. In some embodiments, a size of the hole (e.g., a diameter of the hole) is configured to (e.g., is large enough) to accommodate radial movement of the clamp as the fastener is tightened against the clamp (e.g., radial movement while sliding down the ramp without radially impinging the fastener). In some embodiments, the first and second portions of the clamp are arranged in a plane that is substantially perpendicular to the top surface.

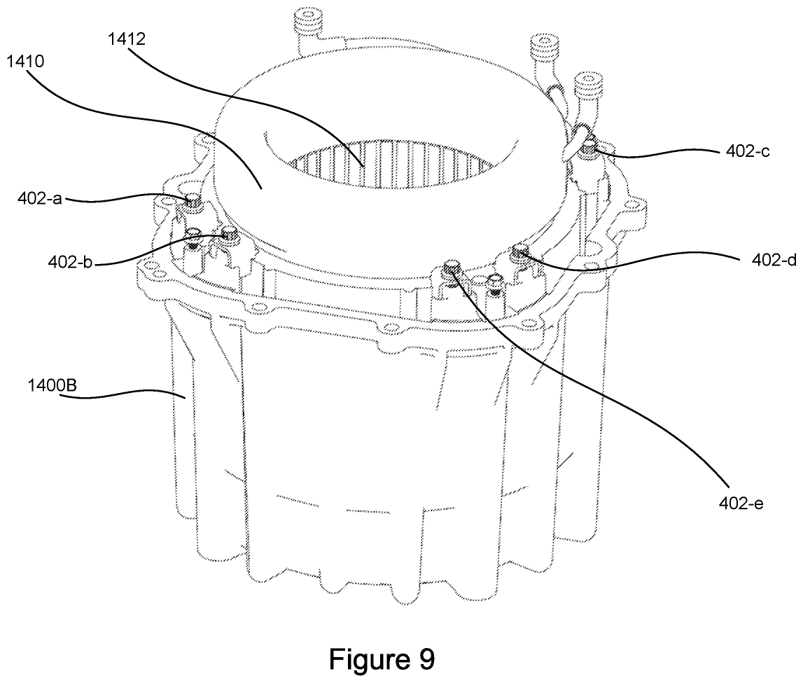

In some embodiments, the clamp comprises a first surface and a second surface (e.g., in addition to the top surface of the clamp) such that a cross-sectional view of the clamp 304 may appear to be “U” shaped (e.g., an upside-down “U”). For example, the top surface corresponds to the horizontal, bottom portion of the “U” and the first surface and the second surface of the clamp correspond to the two vertical sides of the “U.” In some embodiments, the axis of the opening of the boss is perpendicular to the top surface of the clamp. In some embodiments, the first surface and the second surface are identical (e.g., share the same shape). In some embodiments, each of the first and second surfaces includes a first portion to contact the side of the stator to provide a radial force to the stator and a second portion to contact an end of the stator to provide an axial force to the stator. Having more than one first and second portion per clamp (e.g., first and second portions on the first and second surfaces of the clamp) allows the clamp to prevent rotation of the stator relative to the case (see FIG. 9). In some embodiments, each of the first surface and the second surface include a first protrusion, a second protrusion, and a notch (as described above). In some embodiments, the first surface and the second surface are separated by the width of the top surface.

In some embodiments, a gap 502 (e.g., a non-zero distance) exists between the top surface of the clamp and the top of the opening of the boss when the fastener is inserted into the boss. Stated another way, the clamp is configured to produce the gap when seated between the stator and the slanted edge. For example, the fastener may be longer than the length of the boss such that, even when the fastener is tightened completely, a gap 502 remains between the boss and the top portion of the clamp. In some embodiments, the top surface of the clamp does not contact the opening of the boss (or the casting 1400B). In some embodiments, the presence of gap 502 allows for a larger tolerance deviation in the stator height because despite manufacturing deviations (variations) that result in different heights of stators (e.g., a different number of stator laminations stacked to create the stator and/or different thicknesses of the stator laminations), the clamp will lock onto the stator and hold the stator in place (e.g., by clamping the stator to the casting). Thus, the clamp may support the stator through different operating conditions and is compatible with stators of different sizes (e.g., heights). The slanted edge is configured to slide against the ramp when the fastener (e.g., screw) is inserted into the boss to generate the radial force. In some embodiments, the gap 502 is formed by a height of the clamp (measured from the top surface of the clamp through which the fastener is inserted to the second portion of the clamp that contacts the end of the stator to provide the axial force) being greater than a height measured from the top of the boss to the top of the stator.

FIG. 6 illustrates a cross-sectional view of a plurality of clamps. In some embodiments, the first clamp is a plurality of clamps and the boss is a first boss of a plurality of bosses. In some embodiments, each clamp of the plurality of clamps is identical to the other plurality of clamps (e.g., are stamped from the same pattern). In some embodiments, each of the plurality of clamps provides a radial force and an axial force. The plurality of clamps provides an axial force on the end of the stator (e.g., pushing down on the stator parallel to the axis of the stator). In some embodiments, the plurality of clamps provides a radial force inward (e.g., toward the axis of the stator). In some embodiments, the plurality of clamps is arranged circumferentially around the stator at predefined spacings (e.g., apart from each other). The plurality of clamps may be equally spaced apart or unequally spaced apart. In some embodiments, the stator case (e.g., casting 1400B) comprises a plurality of bosses (e.g., the boss 504 is a first boss of the plurality of bosses). In some embodiments, the case (e.g., casting 1400B) includes a plurality of ramps such that the plurality of clamps (e.g., the slanted edges of the plurality of clamps) may slide against the ramp when a respective fastener of the plurality of fasteners is inserted into a respective boss of the plurality of bosses.

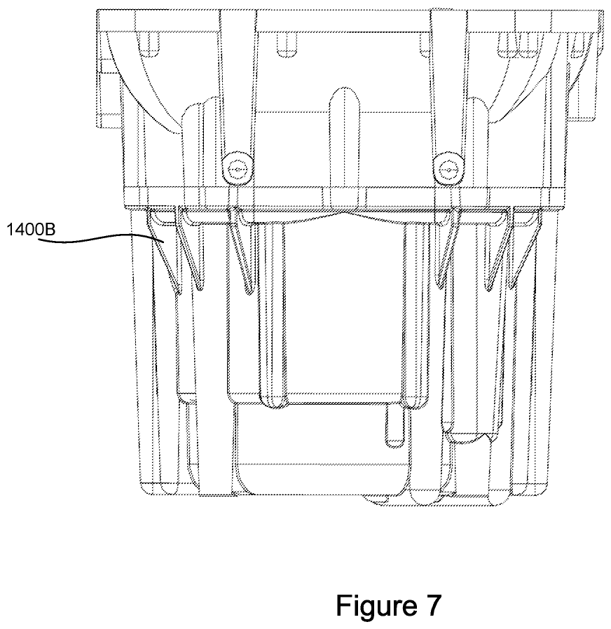

FIG. 7 is a view of the lower portion of casting 1400B, which houses the stator, the rotor, and the stator windings.

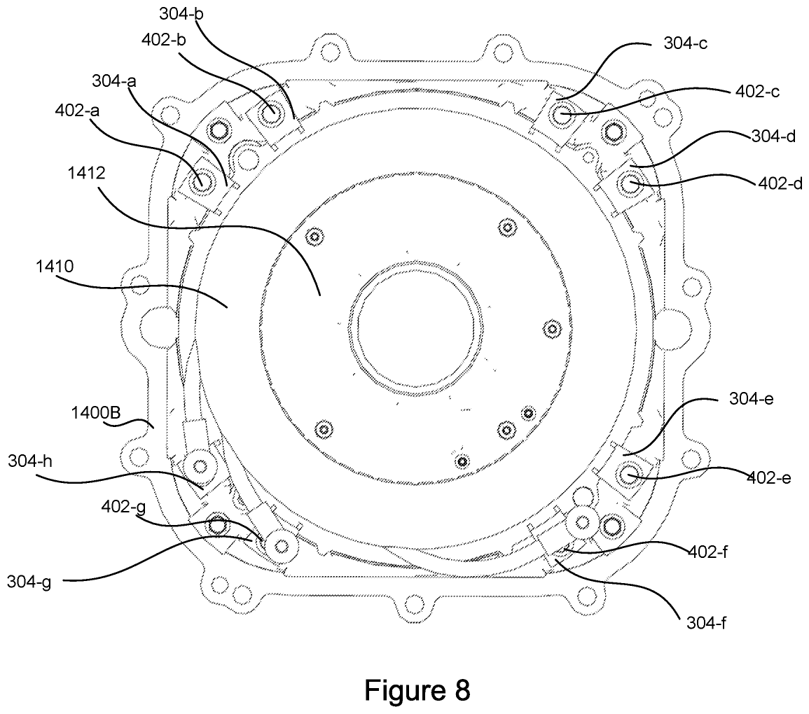

FIG. 8 is a top-view of the motor, showing the top stator windings 1410, the rotor 1412, and the plurality of fasteners 402 (e.g., fasteners 402-a, 402-b, 402-c, 402-d, 402-e, 402-f and 402-g) for holding the stator clamps 304 (e.g., clamps 304-a, 304-b, 304-c, 304-d, 304-e, 304-f, 304-g and 304-h) clamped to the casting 1400B.

FIG. 9 is a view of the casting 1400B, showing a plurality of fasteners 402 (e.g., fasteners 402-a to 402-e) that each configured to receive a fastener for a clamp that stabilizes the stator and the rotor 1412 within the casting 1400B.

It will also be understood that, although the terms first, second, etc. are, in some instances, used herein to describe various elements, these elements should not be limited by these terms. These terms are only used to distinguish one element from another. For example, a first protrusion could be termed a second protrusion, and, similarly, a second protrusion could be termed a first protrusion, without departing from the scope of the various described implementations. The first protrusion and the second protrusion are both protrusions, but they are not the same protrusion unless explicitly stated as such.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations were chosen in order to best explain the principles underlying the claims and their practical applications, to thereby enable others skilled in the art to best use the implementations with various modifications as are suited to the particular uses contemplated.

What is claimed is:

1. A drive unit for an electric vehicle, comprising:
a stator having an axis extending through an opening in a middle of the stator;
a case comprising:
a boss with an opening having an axis, and
a ramp adjacent to the boss and slanting toward the axis of the stator as it extends away from the opening of the boss;
a clamp to fasten the stator within the case, comprising:
a first portion to contact a side of the stator to provide a radial force to the stator;
a second portion to contact an end of the stator to provide an axial force to the stator; and
a slanted edge contacting the ramp;
a fastener inserted through the clamp into the boss;
wherein the slanted edge is configured to slide against the ramp when the fastener is inserted into the boss, to generate the radial force.

2. The drive unit of claim 1, wherein:
the clamp further comprises a top surface through which the fastener is inserted; and
a gap exists between the top surface and a top of the opening of the boss when the fastener is inserted into the boss.

3. The drive unit of claim 1, wherein the fastener inserted through the clamp comprises a screw.

4. The drive unit of claim 3, wherein the boss is configured to receive a screw and the fastener is inserted into the boss by screwing the screw into the boss.

5. The drive unit of claim 1, wherein:
the clamp comprises a first surface and a second surface parallel to the first surface;
the first and second surfaces are coupled to the top surface of the clamp; and
the first and second surfaces are perpendicular to the top surface.

6. The drive unit of claim 1, wherein the clamp comprises stamped sheet metal.

7. The drive unit of claim 1, wherein:
the first portion of the clamp comprises a first protrusion;
the second portion of the clamp comprises a second protrusion, perpendicular to the first protrusion; and
the clamp further comprises a notch formed between the first and second protrusions.

8. The drive unit of claim 1, wherein the notch comprises a rounded cutout.

9. The drive unit of claim 1, wherein:
the clamp is a first clamp of a plurality of clamps, each clamp of the plurality of clamps comprising an identical shape;
the boss is a first boss of a plurality of bosses; and
the fastener is a first fastener of a plurality of fasteners, each fastener inserted through a respective boss of the plurality of bosses into a respective clamp of the plurality of clamps.
